(19) United States
(12) Patent Application Publication
(10) Pub. No.: US 2014/0040862 A1
(43) Pub. Date: Feb. 6, 2014

(54) Copying Reusable Components from a Remote Source

(71) Applicants: Roger R. Webster, San Martin, CA (US); David Tristram, San Jose, CA (US); Simon Towers, San Jose, CA (US)

(72) Inventors: Roger R. Webster, San Martin, CA (US); David Tristram, San Jose, CA (US); Simon Towers, San Jose, CA (US)

(73) Assignee: ADOBE SYSTEMS INCORPORATED, San Jose, CA (US)

(21) Appl. No.: 12/062,487

(22) Filed: Apr. 3, 2008

(51) Int. Cl. G06F 9/44

(52) U.S. Cl. 717/121

(57) ABSTRACT

Methods, systems, and apparatus, including computer program products, for reusing a component. In one aspect, a method includes detecting insertion into a target application of a reusable component associated with a remote source; identifying a library corresponding to the reusable component, wherein the library is maintained at the remote source; loading the library into a storage location accessible to the target application to create a local library; and instantiating the reusable component in the target application in accordance with the local library. Further, limited system privileges can be granted to the reusable component. Additionally, the reusable component can be assigned to a sandbox based on one or more granted system privileges.

### BACKGROUND

The present disclosure relates to inserting a reusable component into a target application based on a reusable application included in a remote source application or application fragment.

The development of software applications has seen many advances since the inception of computing. For example, low-level languages utilized constructs that were very closely related to the hardware of the computing system on which programs were executed. The creation of high-level programming languages provided tools that were more abstract than corresponding low-level programming languages and delivered greater portability across different platforms. High-level programming languages also permitted programmers to express operations in terms of variables, mathematical formulas, and Boolean expressions, rather than memory addresses and registers.

The development of object-oriented programming concepts and object-oriented languages, such as C++, further permitted programmers to modularize software applications. Object-oriented programming emphasizes concepts including encapsulation, inheritance, and modularity. Specific purpose modules can be created using object-oriented techniques, such that the modules receive input from and/or provide output to one or more other modules. Additionally, separate modules in a program can be configured to communicate by passing data organized in accordance with constructs, such as classes, subclasses, and objects. Once created, such specific purpose modules can be reused in other programs by copying the source code and associated definitions.

Java further expanded the principles of object-oriented programming by introducing the concept of a virtual machine, which makes it possible to execute an application in a platform-independent environment. Once configured, the virtual machine exists as an environment above the operating system and the computing platform in which an application executes. Because a virtual machine can operate on a variety of computing platforms, an application can be executed in the virtual machine on any of the supported platforms without requiring customization. Thus, an application can be generated for use with a virtual machine such that the application is reusable across a variety of separate computing platforms.

Programming tools, or integrated development environments (IDEs), still further enhanced the ability of programmers to efficiently develop software applications. A programming tool can be used to prototype, code, debug, and maintain one or more software applications. Further, IDEs often include a graphical programming environment, in which features can be at least partially configured through the use of graphical tools. IDEs also can include a palette of standard components, such as controls and displays, that can be inserted into an application without having to be independently developed. Additionally, IDEs provide the ability to analyze and modify an existing application for which the source code is available.

Further, communications networks and web browser applications were adapted to permit an application hosted or stored on a remote computer to be accessible locally. For example, the Java programming language provides write-once, run anywhere functionality that allows Java-based applications to be run virtually on any computing device. An application can be downloaded, such as in conjunction with a web page, from a remote source and executed in a browser window hosted on a local computing platform. As a result, software applications can be executed over a communications network, either by executing the application directly from a remote source or by downloading the application for local execution.

### SUMMARY

This specification describes technologies relating to reusing one or more components included in an existing application or file system object within a networked computing environment. A reusable component included in a remote source application or represented by a remote file system object can be inserted into a local target application or file system view. A reusable component also can be transferred from a local source to a remote target. In some implementations, a reusable component associated with a first remote system can be transferred to a target application or file system view corresponding to a second remote system, such as through one or more operations initiated at a local system. An existing application, including an application executing within the context of a web browser, can be configured to identify one or more reusable components included in the application. For example, a reusable component can be displayed such that it is visually distinguishable from the non-reusable components of an application, including through highlighting, low-lighting, outlining, shading, or any other such visual indication. Further, a reusable component can be inserted into a separate application, including a web-based application, that is being executed in a compatible application environment. The application environment can be configured such that a reusable component included in an existing application, the source application, can be selected and transferred to a target application through a graphical user interface command, such as a drag-and-drop operation. Additionally, the reusable component can be automatically inserted into the target application in response to being “dropped” in a display space associated with the target application.

Further, a reusable component also can be represented as an application fragment that exists as a file system object. The application environment can be configured such that a reusable component copied from a source application, including a web-based application, can be transferred into any view into a file system, e.g. a desktop or file folder, through an operation, such as a paste or drop. Additionally, the reusable component can be automatically captured as a persistent application fragment upon being transferred into the file system. An application fragment also can be transferred into an existing application, such as a web-based application, to instantiate a corresponding reusable component.

The present inventors recognized the need to permit switching a running application into a mode that facilitates reuse of one or more components. Further, the present inventors recognized the need to automatically insert instructions associated with a reusable component into the code of a receiving target application or a persistent file system representation. In order to facilitate reuse in a networked computing environment, the present inventors recognized that it would be beneficial to permit transferring a reusable component from and/or into a remote application, such as an application executing in a web browser hosted in a computing system.

The present inventors also recognized the need to permit controlling the permissions or privileges accorded to a reusable component transferred from a remote application into a local target application. Further, the present inventors recognized the need to permit retrieving information associated with a reusable component from a remote location. Accordingly, the systems and apparatus described here can implement methods for identifying and sharing one or more reusable components between a plurality of applications and/or file systems, including sharing through one or more remote applications.

In general, in one aspect, the subject matter can be implemented to include detecting insertion into a target application of a reusable component associated with a remote source, accessing a library corresponding to the reusable component, wherein the library is maintained at the remote source, loading the library into a storage location accessible to the target application to create a local library, and instantiating the reusable component in the target application in accordance with the local library.

The subject matter also can be implemented to include granting limited system privileges to the reusable component. Also, the subject matter can be implemented to include assigning the reusable component to a sandbox based on one or more granted system privileges. Further, the subject matter can be implemented such that the library includes an implementation of one or more reusable components. Additionally, the subject matter can be implemented such that detecting insertion further includes detecting an operation dropping the reusable component in a target application window corresponding to the target application.

The subject matter also can be implemented to include retrieving, by the target application, information associated with the reusable component from a clipboard. Further, the subject matter can be implemented such that the reusable component is defined in an application fragment. Additionally, the subject matter can be implemented such that the reusable component is a dynamic component configured to retrieve one or more executable instructions from a remote location.

In general, in another aspect, the techniques can be implemented as a computer program product, encoded on a computer-readable medium, operable to cause data processing apparatus to perform operations including detecting insertion into a target application of a reusable component associated with a remote source, accessing a library corresponding to the reusable component, wherein the library is maintained at the remote source, loading the library into a storage location accessible to the target application to create a local library, and instantiating the reusable component in the target application in accordance with the local library.

The subject matter also can be implemented to be further operable to cause data processing apparatus to perform operations including granting limited system privileges to the reusable component. Also, the subject matter can be implemented to be further operable to cause data processing apparatus to perform operations including assigning the reusable component to a sandbox based on one or more granted system privileges. Further, the subject matter can be implemented such that the library includes an implementation of one or more reusable components. Additionally, the subject matter can be implemented such that detecting insertion further includes detecting an operation dropping the reusable component in a target application window corresponding to the target application.

The subject matter also can be implemented to be further operable to cause data processing apparatus to perform operations including retrieving information associated with the reusable component from a clipboard. Further, the subject matter can be implemented such that the reusable component is defined in an application fragment. Additionally, the subject matter can be implemented such that the reusable component is a dynamic component configured to retrieve one or more executable instructions from a remote location.

In general, in another aspect, the subject matter can be implemented as a system including a target application stored on a computer-readable medium and a computing system including processor electronics configured to perform operations including detecting insertion into the target application of a reusable component associated with a remote source, accessing a library corresponding to the reusable component, wherein the library is maintained at the remote source, loading the library into a storage location accessible to the target application to create a local library, and instantiating the reusable component in the target application in accordance with the local library.

The subject matter also can be implemented such that the processor electronics are further configured to perform operations including granting limited system privileges to the reusable component. Also, the subject matter can be implemented such that the processor electronics are further configured to perform operations including assigning the reusable component to a sandbox based on one or more granted system privileges. Further, the subject matter can be implemented such that the library includes an implementation of one or more reusable components. Additionally, the subject matter can be implemented such that detecting insertion further includes detecting an operation dropping the reusable component in a target application window corresponding to the target application.

The subject matter also can be implemented such that the processor electronics are further configured to perform operations including retrieving information associated with the reusable component from a clipboard. Further, the subject matter can be implemented such that the reusable component is defined in an application fragment. Additionally, the subject matter can be implemented such that the reusable component is a dynamic component configured to retrieve one or more executable instructions from a remote location.

Particular embodiments of the subject matter described in this specification can be implemented to realize one or more of the following advantages. For example, the subject matter can be implemented to transfer or otherwise copy a reusable component from a remote source application into a local target application or file system without having to manually access the source code associated with the reusable component. The subject matter also can be implemented to transfer or otherwise copy a reusable component from a local source application or file system into a remote target application without having to manually access the source code associated with the reusable component. Further, the subject matter can be implemented permit transferring a reusable component or application fragment corresponding to a reusable component from a remote source to a remote target. The subject matter also can be implemented to share both reusable components that have a persistent user interface representation and reusable components that lack a persistent user interface representation. Additionally, the subject matter can be implemented to restrict the privileges or access granted to a reusable component transferred into a local application from a remote application. The subject matter also can be implemented to validate the source of a reusable component transferred from a remote application, such as a web-based application.

This subject matter can be implemented using an apparatus, a method, a system, a computer program product, or any combination of an apparatus, methods, systems, and computer program products. The details of one or more embodiments of the invention are set forth in the accompanying drawings and the description below. Other features, aspects, and advantages of the invention will become apparent from the description, the drawings, and the claims.

### BRIEF DESCRIPTION OF THE DRAWINGS

FIGS. 1A and 1B show an exemplary interface that can be used to share one or more reusable components between local and remote applications.

FIG. 2 shows an exemplary interface that can be used to share one or more reusable components between remote applications.

FIGS. 3A and 3B show an exemplary interface that can be used to share one or more application fragments between sources and targets.

FIG. 4 shows a flowchart describing an exemplary process for securing an instance of a reusable component inserted into a target application.

FIG. 5 shows a flowchart describing an exemplary process for generating an instance of a reusable component in a target application.

FIG. 6 shows a computer-implemented method of reusing a component.

FIG. 7 shows an exemplary computing environment.

Like reference numbers and designations in the various drawings indicate like elements.

### DETAILED DESCRIPTION

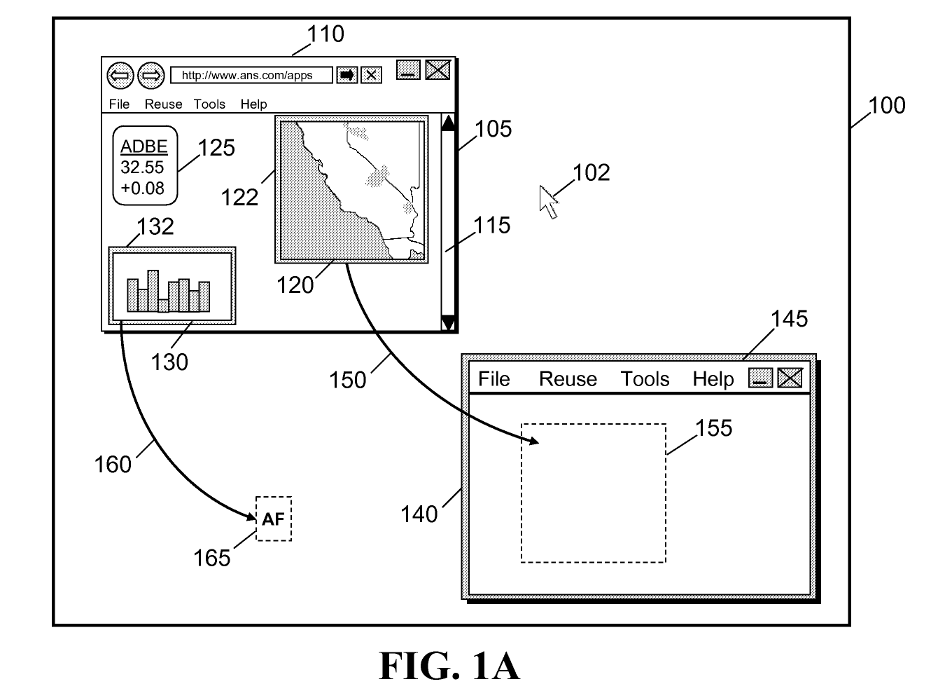

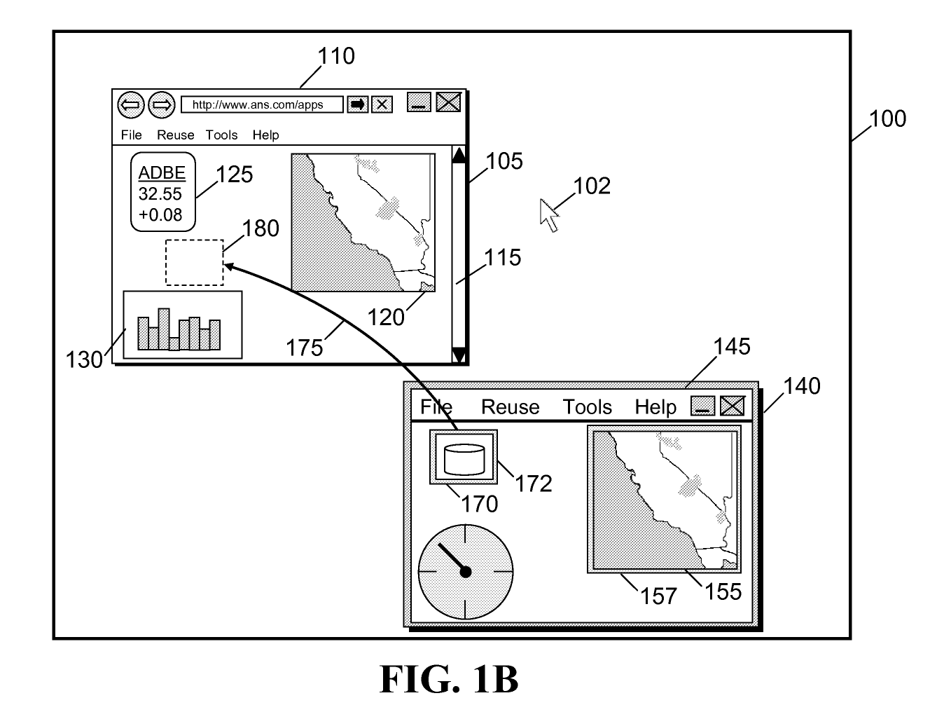

FIG. 1A shows an exemplary interface that can be used to share one or more reusable components between a remote application, such as a web-based application, and a local application. A reusable component is an element of a computer program that includes one or more instructions operable to implement one or more functions, where the component can be extracted from one application program and used again in the context of a separate application program. In one example, a reusable component can implement a stock ticker, which can be configured to present information relating to one or more securities. The reusable component further can be configured to retrieve data from one or more data sources, including local data sources and remote data sources. A reusable component also can be associated with a data source, including the output of another component. An application from which a reusable component is shared is referred to as a source application and an application into which a reusable component is inserted is referred to as a target application.

The interface can be presented in a graphical user interface (“GUI”) environment, such as a desktop 100 presented by an operating system or an application environment associated with a local computing system. The desktop 100 can be configured to permit launching one or more applications (or “computer programs”). Further, the desktop 100 can permit a user to interact with an application through one or more inputs and controls, including graphical controls. For example, a user can control a cursor 102 displayed in the desktop 100 through a physical input device, such as a mouse or trackball, and enter commands to perform one or more operations. Other input devices can include a keyboard, touch screen, touch pad, joystick, and voice interface.

A remote application can be represented in the desktop 100 by a remote application window 105, such as a web browser window or a window corresponding to a cross-platform runtime environment. In the example of FIG. 1A, the remote application is a source application from which a reusable component can be copied. Generally, an application can be both a source and a target. However, a source application also can be locked against further modifications. In some implementations, the remote application can be executed at a remote host with the results displayed in the remote application window 105. In other implementations, a copy of the remote application can be downloaded from the remote host and executed locally with the results displayed in the remote application window 105. For example, at least a portion of an application can be downloaded from a remote host and executed locally by a web browser application or a cross-platform runtime environment.

The remote application window 105 can include a command menu 110 that includes a plurality of commands associated with functions that can be performed by the remote application. The functions can include functions of the remote application, browser application functions, or any combination thereof. For example, the command menu 110 can include web browser controls, such as an address bar and navigation controls. The command menu 110 also can include a plurality of menu titles, which further can correspond to any number of options and sub-menus. The command menu 110 also can include one or more command buttons associated with specific functions, such as minimizing or closing the remote application window 105. In some implementations, the command menu 110 can be implemented as a reusable component.

A “reuse” menu option can be include in the command menu 110. In some implementations, the reuse menu option can be implemented as a single function that can be toggled between an “on” setting and an “off” setting, such as by selecting the reuse menu option through a user input device. In other implementations, the reuse menu option can be implemented to include one or more submenus and/or options, which can be selected to control reuse functionality. Further, a visual indicator can be associated with the reuse menu option to identify the present state of reuse, such as “on” or “off”. When the reuse function is turned off, a source application, such as the remote application, can perform routine operations, including executing the functions associated with one or more components included in the source application. When the reuse function is turned on, the source application can identify the components that are available for reuse. A reusable component included in the source application can be identified through a wide variety of indicators, including visual and/or auditory indicators provided through the interface. For example, a visible border can be presented around a reusable component. In some implementations, turning the reuse function on also enables drag-and-drop functionality that can be used to insert a reusable component into a target application.

Further, a source application, such as the remote application, can be configured such that turning on the reuse function inhibits interaction with reusable components for functions other than insertion into a target application. For example, when the reuse function is turned on in a source application, one or more command interfaces associated with a reusable component can be disabled. Thus, selecting a button included in a reusable component will not produce a button “click” event or initiate the corresponding functionality that results when the reuse function is turned off. Additionally, interaction with non-reusable components included in a source application also can be inhibited when the reuse function is turned on. For example, a movie player can be configured to continue playing, but associated controls such as pause and rewind can be disabled so that the movie player is inert.

The remote application also can include a scroll bar 115 that allows for the selective display of content include in the remote application window 105. In some implementations, the scroll bar 115 can be implemented as a reusable component. Additionally, one or more other components associated with the remote application can be displayed in the remote application window 105. For example, a weather monitor 120 can be configured to display the current weather conditions for a particular region of the terrestrial globe. The weather monitor 120 also can be configured to present other information, such as time, temperature, and forecast data. The information presented by the weather monitor 120 can be collected from one or more data sources, including data sources external to the remote host. When reuse is on, the weather monitor 120 also can include a visible border 122 to indicate that it is a reusable component. Further, a stock ticker 125 can be configured to present quotes for one or more securities or indexes. Similar to the weather monitor 120, the stock ticker 125 also can be configured to retrieve quote data from one or more data sources, including data sources external to the remote host. Additionally, an output monitor 130 can be displayed in the remote application window 105. The output monitor 130 can provide a graphical representation of the values associated with a data source. For example, the output monitor 130 can provide a visual representation of sound being received through a microphone that is connected to the computing platform on which the remote application is hosted or sound data stored in an electronic file. When reuse is on, the output monitor 130 also can include a visible border 132 to indicate that it is a reusable component.

A local application also can be represented in the desktop 100 by a local application window 140. In the example of FIG. 1A, the local application is a target application into which a reusable component is inserted. The local application can be a newly created (or “blank”) application that is being developed. In some implementations, a blank application can be created by selecting a “New Application” option from a menu, such as a program menu presented by an operating system or application environment. A blank application also can be created by selecting a “New Application” option from a context menu, such as a menu displayed in response to right clicking in an existing application executing within an application environment or in the desktop 100. Further, the blank application can be configured in accordance with an application template and then launched as an executing application, such as in an application environment. Alternatively, the local application can be an existing application that has not been locked to prevent modification.

The local application window 140 can include a command menu 145, which can be configured to list a plurality of commands associated with functions that can be performed by the local application. For example, the command menu 145 can include any or all of the remote application functions included in the command menu 110 of the remote application window 105. The command menu 145 also can include commands associated with other functions of the local application. If the local application is a newly created application, the command menu 145 can include standard functions, such as save, exit, and help. As functionality is added to the local application, such as through the addition of one or more components, the command menu 145 can be expanded to include options and sub-menus associated with the expanded functionality. In an implementation, the command menu 145 also can be modified through the use of an application development tool.

In the example of FIG. 1A, the weather monitor 120 includes the visible border 122 to indicate that the weather monitor 120 is a reusable component. A visible border associated with a reusable component can be displayed to create a defined border around the reusable component that includes a different color or texture than the presentation of a non-reusable component included in the same window. Alternatively, the visible border can be presented as a “glow” or “halo” effect that surrounds the reusable component. In some implementations, the visible border associated with a reusable component can be displayed persistently. In other implementations, the visible border associated with a reusable component can be displayed intermittently in response to an interface event, such as in response to a cursor coming within a predetermined range of the reusable component. Further, non-reusable components also can be visually distinguished from reusable components by diminishing their visual presentation in the application window, such as by fading or graying the non-reusable components. Diminishing the visual presentation of non-reusable components can be performed in conjunction with or instead of enhancing the visual presentation of reusable components, such as through the use of a visible border. Interface components and controls also can include a visible border if they are reusable.

A reusable component can be grabbed (or selected) from a source application in the desktop 100, such as through the use of the cursor 102 controlled by an input device. The framework within which the source application is executing can detect the initiation of a drag operation involving a reusable component. For example, an overlay can be placed over at least a portion of the content space associated with the source application. The overlay also can be at least partially transparent, such that the one or more components in the content space are visible through the overlay. In some implementations, the overlay can be generated in response to turning on the reuse function. Further, the overlay can be configured to detect a mouse event and determine, such as through a mapping, the underlying component that corresponds to the mouse event. Alternatively, a frame or other such boundary can be associated with one or more of the reusable components included in the source application. The frame can substantially conform to the footprint of the component in the source application window. In such implementations, the frame can be used to detect a mouse event involving the corresponding component.

Once grabbed, the reusable component can be inserted into a target application through a drag-and-drop operation. For example, the weather monitor 120 can be grabbed in the remote application window 105 and dragged 150 across the desktop 100 to the local application window 140. The drag-and-drop operation can be represented in the desktop 100 by the operating system of the host computing system. Further, the local application can be registered to accept drag-and-drop events and can be notified of the drop event by the host operating system. By dropping the weather monitor 120 in the local application window 140, a new weather monitor 155 is inserted into the local application.

The weather monitor 155 generated in the local application through the drag-and-drop operation can selectively incorporate the functionality of the weather monitor 120 in the remote application, including one or more of the configuration settings associated with the weather monitor 120 at the time it was copied. Thus, the weather monitor 155 inserted into the local application can be initialized to a state that corresponds to the state of the weather monitor 120 in the remote application when the copy procedure began. For example, the weather monitor 155 inserted into the local application can be configured to present weather data for the same geographical area as the weather monitor 120 associated with the remote application.

In some implementations, information associated with the reusable component, such as the weather monitor 120, in the source application is copied into a system clipboard, such as that used for cut, copy, and paste operations. For example, the framework within which the source application is executing can detect a mouse operation moving a reusable component. Further, the framework can copy one or more items of information associated with that reusable component to the clipboard in anticipation of a drag-and-drop operation. Additionally, in some implementations, information can be copied to the clipboard in response to movement of a component only when the reuse function is turned on. The clipboard receives information sufficient to instantiate in the target application an instance of the reusable component being copied. For example, the clipboard can receive a name describing the reusable component, a pointer to a library implementing the reusable component, and one or more items of state information describing the state of the reusable component being copied from the source application. The pointer can be any location identifier, including a URI or a URL. Further, the pointer can indicate a library corresponding to the source application or a library associated with a separate location. In some implementations, the pointer can identify an embedded application that can be downloaded. In other implementations, byte code associated with the source application can be loaded into the clipboard instead of a pointer. Further, a library can include an implementation of one or more reusable components. Additionally, the reusable component can be a dynamic component, which can be configured to retrieve computer code from one or more other sources. Once an instance of a dynamic component has been created, the dynamic component can perform one or more functions, including loading additional computer code to further develop or expand the dynamic component.

The local application receiving the reusable component can be registered with the host operating system to receive notification of drop events. Further, the clipboard can include all of the composable data (describing the reusable component) from the source application that is necessary to generate an instance of the reusable component in the target application. Upon detecting the occurrence of a drop event within the local application window 140, the local application can access the clipboard to identify the composable data corresponding to the reusable component that has been dropped. For example, the local application can parse the composable data to identify the pointer to the library implementing the reusable component and further can request the application runtime to load the library. Once the library has been loaded, the local application also can request the application runtime to generate an instance of the reusable component based on the library. Additionally, the local application can access the one or more items of state information included in the clipboard and can modify the reusable component in accordance with the state information.

Further, a target application can limit the functionality of a received reusable component by sandboxing the reusable component. For example, the target application can structure an environment (or sandbox) in the local computing system in which the reusable component can be executed. Thus, the target application can provide one or more privileges that make a specific set of resources available to the reusable component, such as disk space and memory. Further, the environment structured by the target application can prevent the reusable component from accessing other system resources, such as network communications, file system access, and the ability to read from one or more input devices.

In some implementations, the reusable component can be restricted such that it does not have any further system privileges (or “privileges”) than if it were running in a remote application window 105. In other implementations, the reusable component can be analyzed to determine the set of privileges it requires and the local application can limit the reusable component to those privileges or a subset of those privileges. Further, a number of sandboxes with different privileges and access permissions can be created for use by reusable components. At least a portion of the restrictions imposed on a reusable component also can be lifted, such as once the reusable component has been verified or validated. Alternatively, a reusable component can be given full privileges when it is generated, if the reusable component is received from a trusted source or is otherwise validated by the target application.

A reusable component also can be manipulated after it has been inserted into the target application. For example, the weather monitor 155 can be resized, moved, or deleted once it is displayed in the local application window 140. Further, a target application can be modified using one or more development tools, such as by opening or accessing the target application in an IDE. For example, a target application that has been populated with one or more reusable components can be opened as a project in an IDE. In some implementations, a menu item can be selected to generate a project from the target application that can be opened in an IDE. Further, code corresponding to one or more components included in the target application can be converted, such as into a markup language or ActionScript, to generate a project. In some implementations, source code can be automatically retrieved for one or more components included in a target application when the application is opened as a project. For example, a source code pointer included in a component, such as a URL or URI, can be accessed to retrieve corresponding source code. Alternatively, if a source code pointer is not available, the binary form of the component can be used in the IDE.

Additionally, a reusable component can be selected in a source application and dragged into a view of the file system. The file system view can include any access to the file system, such as a file folder, a file directory, or an open space on the desktop 100. In some implementations, the file system view also can be of a remote file system, such as a networked folder or directory. By dropping the reusable component in the file system view, an application fragment representing the reusable component is created in the file system of the corresponding computing device. For example, the output monitor 130 can be selected in the remote application window 105 and dragged 160 to an open location in the desktop 100. Upon executing a drop operation, an application fragment 165 corresponding to the output monitor 130 is created in the file system of the computer system presenting the desktop 100. The application fragment is then preserved as a persistent, on-disk representation of the output monitor 130.

In some implementations, information associated with the reusable component can be copied into a system clipboard associated with the computing device. For example, the clipboard can receive a name describing the reusable component, a pointer to a library implementing the reusable component, and one or more items of state information describing the state of the reusable component. Further, a temporary file including a serialized representation of the clipboard contents can be generated during the copy operation, such as when the drag operation is initiated. The location of the temporary file also can be added to the clipboard as a data source. Dropping the selected reusable component onto a location in a file system view can cause the temporary file to be moved to that location. The application fragment 165 then can be operated on in the same manner as other data files stored, temporarily or persistently, in the computing system. For example, the application fragment 165 can be copied, moved, deleted, inserted into a document, or appended to an electronic mail message. In some implementations, the application fragment also can include an indicator identifying that it was generated based on a reusable component from a remote source.

FIG. 1B shows an exemplary interface that can be used to share one or more reusable components between a local application and a remote application, such as a web-based application. In the example of FIG. 1B, the local application, represented by the local application window 140, is the source application from which a reusable component can be copied and the remote application, represented by the remote application window 105, is the target application into which a reusable component can be inserted. The reuse function can be turned on in the local application window 140 by selecting a reuse option in the command menu 145. When reuse is turned on, any reusable components included in the local application window 140 can be identified. For example, a visible border 157 can be presented in association with the weather monitor 155 to indicate that the weather monitor 155 is a reusable component.

Further, a reusable component that generally does not have an associated visual presentation can be represented by an icon when the reuse function is turned on. For example, when reuse is turned on, a database icon 170 can be presented in the local application window 140. The database icon 170 can be used to represent a data source accessible to the local application that does not have a visual representation when the reuse function is turned off. Further, the database icon 170 can be presented with a visible border 172 to indicate that it is reusable. The database icon 170 can be selected in the local application window 140, such as by positioning the cursor 102 over the database icon 170 in the local application window 140. The database icon 170 then can be dragged 175 to a position in the remote application window 105. By dropping the database icon 170 in the remote application window 105, a new data source 180 is inserted into the remote application. The data source 180 generated in the remote application through the drag-and-drop operation can provide access to the same data as the data source represented by the database icon 170 in the local application. Further, the data source 180 can be automatically or manually associated with one or more other components included in the remote application window 105.

As describe with respect to FIG. 1A, information sufficient to instantiate an instance of the data source corresponding to the database icon 170 can be transferred to the remote application, such as by copying the information into the system clipboard. Further, the remote application can limit the functionality of the received reusable component by sandboxing the data source or otherwise limiting its access to one or more system resources on the remote host. In some implementations, the remote host can be configured to prevent the insertion of a reusable component into the remote application, such as by locking the remote application.

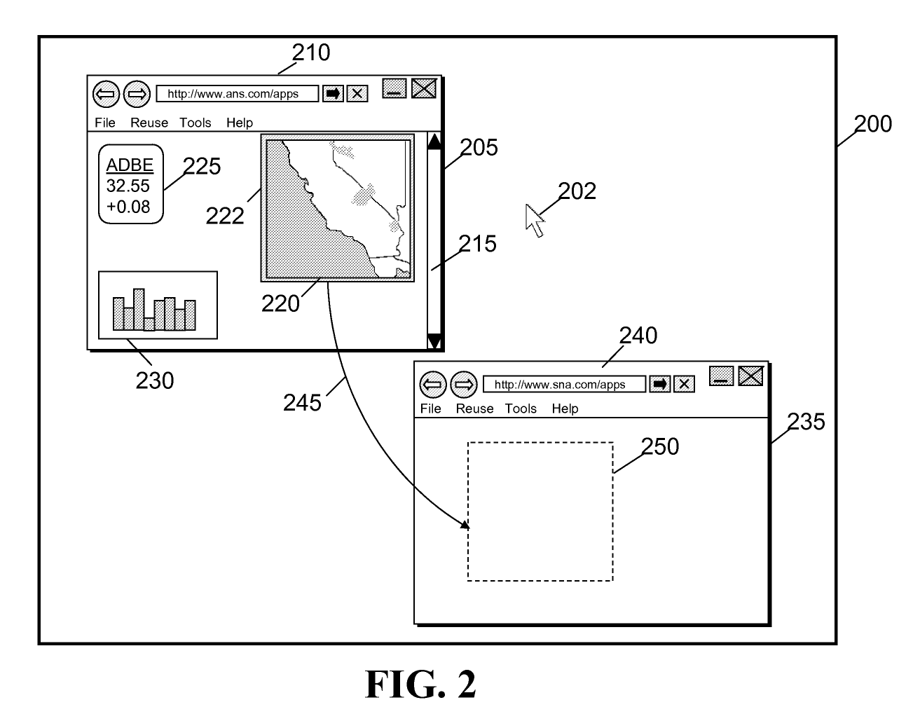

FIG. 2 shows an exemplary interface that can be used to share one or more reusable components between remote applications. A desktop 200 associated with a local computing system can present a remote source window 205 associated with a remote source application. The remote source window 205 can have a command menu 210 that includes a plurality of commands associated with functions that can be performed by the remote source application. The remote source window 205 also can include a scroll bar 215 to permit selective display of content include in the remote source window 205 and a cursor 202 that can be controlled through a physical input device. Further, the remote source window 205 can include one or more components. For example, the remote source window can include a weather monitor 220, a stock ticker 225, and an output monitor 230. Additionally, as described with respect to FIG. 1A, a reuse option associated with the remote source application can be selected to enable sharing of one or more reusable components. When the reuse option is selected, each of the reusable components included in the remote source application can be visibly indicated. For example, the weather monitor 220 can be presented with a visible border 222 to indicate that the weather monitor 220 is a reusable component.

The desktop 200 also can present a remote target window 235 associated with a remote target application. In some implementations, the remote source application and the remote target application can correspond to separate remote hosts. In other implementations, the remote source application and the remote target application can correspond to the same remote host. Further, the remote source window 205 and the remote target window 235 can be web browser windows associated with one or more web browser applications or windows corresponding to a cross-platform runtime environment.

The remote target window 235 also can include a command menu 240, which can be configured to list a plurality of commands associated with functions that can be performed by the remote target application. Additionally, the remote target application can be a newly created application into which one or more components can be inserted. Alternatively, the remote target application can be an existing application that includes one or more components and has not been locked to prevent further modification, such as the insertion of a reusable component.

The weather monitor 220 presented in the remote source window 205 can be selected, such as through the use of the cursor 202 controlled by a user-input device. Once selected, the weather monitor 220 can be inserted into the remote target application through a drag-and-drop operation. For example, the weather monitor 220 can be dragged 245 across the desktop 200 to the remote target window 235. By dropping the weather monitor 220 in the remote target window 235, a new weather monitor 250 is inserted into the remote target application. The newly instantiated weather monitor 250 also can be a reusable component in the remote target application.

In some implementations, information associated with the weather monitor 220 in the remote source application is copied into a clipboard, such as the local system clipboard. The clipboard can receive information sufficient to generate an instance of the reusable component being copied in a receiving application. For example, the clipboard can receive a name describing the reusable component, a pointer to a library implementing the reusable component, and one or more items of state information describing the state of the reusable component being copied from the remote source application. The pointer can be any location identifier, including a URI or a URL. In some implementations, the pointer can identify an embedded application that can be downloaded. Also, a library can include an implementation of one or more reusable components. Additionally, the reusable component can be a dynamic component, which can be configured to retrieve computer code from one or more other sources. The information associated with the weather monitor 220 then can be copied from the clipboard into the remote target application, which can use the copied information to instantiate the weather monitor 250.

Further, the remote target application can limit the access of the weather monitor 250 to one or more resources available in the computing system hosting the remote target application, such as by sandboxing the weather monitor 250. The degree to which the privileges of the weather monitor 250, or another reusable component inserted into the remote target application, are limited can depend on the source application from which the reusable component is received. For example, a reusable component received from a trusted source may not have any limitations imposed on it, while stringent limitations can be imposed on a reusable component received from an anonymous or untrusted source. Thus, the degree to which privileges are granted for a reusable component copied from a remote source can be determined based on the remote source application and not the intermediate local host through which the transfer of the reusable component is executed.

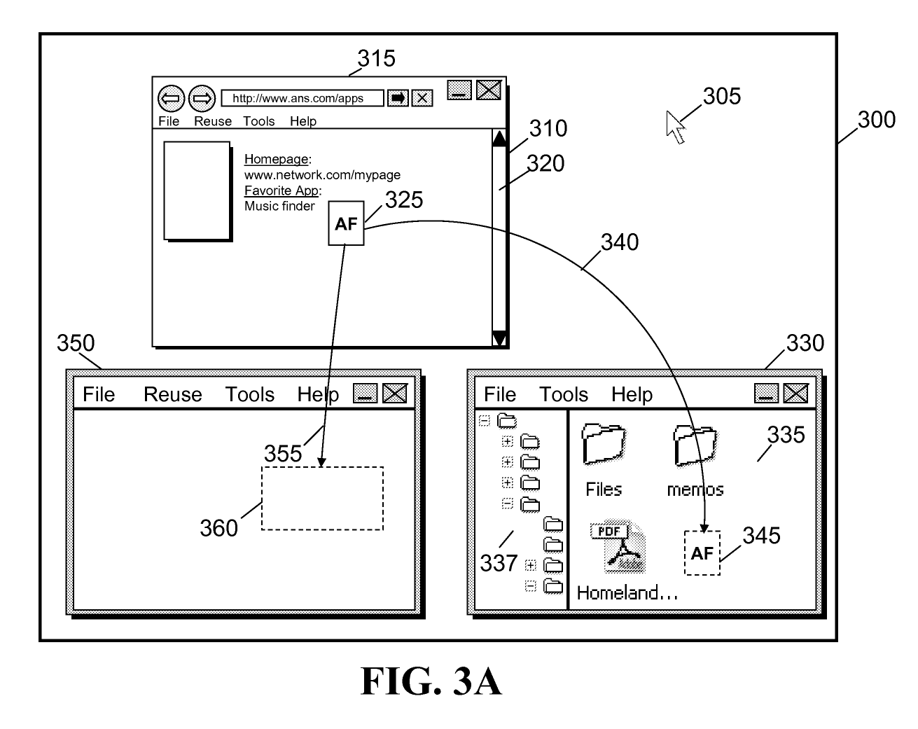

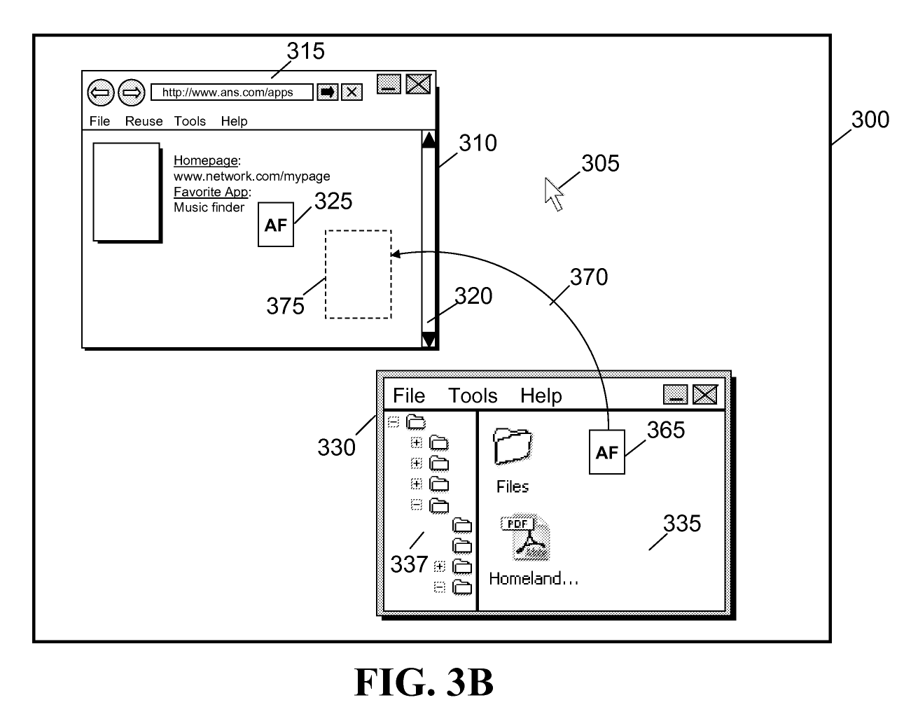

FIG. 3A shows an exemplary interface that can be used to share one or more application fragments between a remote source, such as a web-based application, and a local file system view. The interface can be presented in a GUI environment, such as a desktop 300 presented by an operating system or an application environment associated with a local computing system. A user can interact with the GUI environment through a number of control interfaces, including an on-screen cursor 305 controlled by a physical input device, such as a mouse or trackball, and enter commands to perform one or more operations.

A remote application window 310, which corresponds to a remote source application, can be presented in the desktop 300. For example, the remote source application can be a web-based application that can be presented in a window of a web browser application or a window corresponding to a cross-platform runtime environment. The remote application window 310 can include a command menu 315 that includes a plurality of commands associated with the remote source application, including functions associated with the web browser application. The remote source application also can include a scroll bar 320 that allows for the selective display of content include in the remote application window 310. Further, the remote source application can include one or more application fragments, such as the application fragment 325, which correspond to reusable component(s). The remote application window 310 also can include one or more reusable components (not shown), which can be selected and transferred to a local file system view or local application as discussed with respect to FIG. 1A. In some implementations, the remote application window 310 can include a markup language document, such as a web page, that includes one or more application fragments, such as the application fragment 325. For example, the remote application window 310 can represent a page of a social networking site, an electronic mail or text message, a blog, or any other such web page.

The application fragment 325 can include one or more items of data describing the corresponding reusable component, such as one or more properties. For example, the application fragment 325 can be configured as a specification of how a component can be instantiated in a target application. The application fragment 325 also can include information describing a location at which an implementation of the component can be found, such as a link to source code corresponding to the component. Additionally, the information included in the application fragment can be represented in any format, including binary data, text, or a mark-up language such as Extensible Markup Language (XML).

In some implementations, an application fragment can be configured as a serialization of a plurality of objects, such as Adobe Flex ActionScript Objects offered by Adobe Systems Incorporated of San Jose, Calif. The objects in an application fragment can describe one or more components, which can be associated with a local computing device or a remote computing device. Further, the objects can disclose one or more of the application name with which the component is associated, the class of the component, a path to a file representing a definition of the component, one or more properties of the component, one or more styles associated with the component, and an address at which source code corresponding to the component can be obtained.

An application fragment, such as the application fragment 325, can be preserved as a persistent, on-disk representation of a corresponding reusable component. The application fragment also can represent the state of the corresponding reusable component at the time it was dragged from a source application, a default state of the reusable component, or any combination thereof. Further, a file icon can be used to visually represent an application fragment, such as in the desktop 300 or a file directory. The file icon associated with the application fragment can indicate the nature of the corresponding reusable component, such as by presenting a thumbnail image of the reusable component or by presenting a standard appearance associated with the class of the reusable component.

The application fragment 325 can be selected in the remote application window 310 and dragged to a view of the local file system. For example, a local directory window 330 can include a directory pane 335 indicating one or more stored files and folders. The local directory window 330 also can include a hierarchical directory structure 337. The application fragment 325 can be dragged 340 to a location in the local directory window 330 and dropped. For example, dropping the application fragment 325 in the directory pane 335 causes a new application fragment 345 to be created in that logical file system location. The new application fragment 345 is a copy of the application fragment 325 associated with the remote application window 310. The application fragment 325 in the remote application window 310 also can be selected and dragged to any other file system view, such as a folder in the hierarchical directory structure 337 or an open location in the desktop 300.

Further, the desktop 300 can include a local application window 350, which can correspond to a new application or an existing application that can be modified. The application fragment 325 also can be dragged 355 from the remote application window 310 to the local application window 350 and dropped. Dropping the application fragment 325 in the local application window 350 can cause an instance of a reusable component 360 corresponding to the application fragment 325 to be created. The instance of the reusable component 360 can be initialized to a state that corresponds to the state of the reusable component when the application fragment was generated or a default state. Further, the local application can limit the functionality of the reusable component 360 through limiting the privileges granted to the reusable component 360, such as by sandboxing. One or more of the limitations imposed on the reusable component 360 can be lifted, such as once the reusable component 360 has been verified or validated. Alternatively, a reusable component 360 can be given full privileges if it is received from a trusted source or is otherwise validated by the target application.

FIG. 3B shows an exemplary interface that can be used to share one or more application fragments between a local source, such as a file system view, and a remote application window, such as a web-based application presented in a web browser window or a window corresponding to a cross-platform runtime environment. The application fragment 365 included in the local directory window 330 can be selected and dragged 370 to the remote application window 310. An application fragment also can be selected from any other local file system view or remote file system view available in the desktop 300. Dropping the application fragment 365 in the remote application window 310 causes an instance of a reusable component 375 corresponding to the application fragment 365 to be created. Alternatively, a new application fragment corresponding to the application fragment 365 can be created in the remote application window 310. For example, upon dropping the application fragment 365, the user can be presented with an option to instantiate a new reusable component or insert an application fragment into the target application. Alternatively, the selection between instantiating a reusable component and inserting an application fragment can be made automatically, such as based on one or more configuration settings associated with the target application. Further, the instance of the reusable component 375 can be sandboxed to limit its functionality within the target application. One or more of the restrictions imposed on the reusable component 375 can be lifted, such as once the reusable component 375 has been verified or validated. Alternatively, a reusable component 375 can be given full privileges if the corresponding application fragment is received from a trusted source or is otherwise validated by the target application.

In some implementations, the remote application window 310 can include a markup language document, such as a web page. For example, the remote application window 310 can represent a page of a social networking site, an electronic mail or text message, a ‘blog’, or any other such web page. The application fragment 365 dropped in the remote application window 310 thus can be stored as a persistent file object in association with the markup language document. When the remote application window 310 is subsequently viewed, a representation of the application fragment can be displayed such that it can be selected and dragged from the remote application window 310.

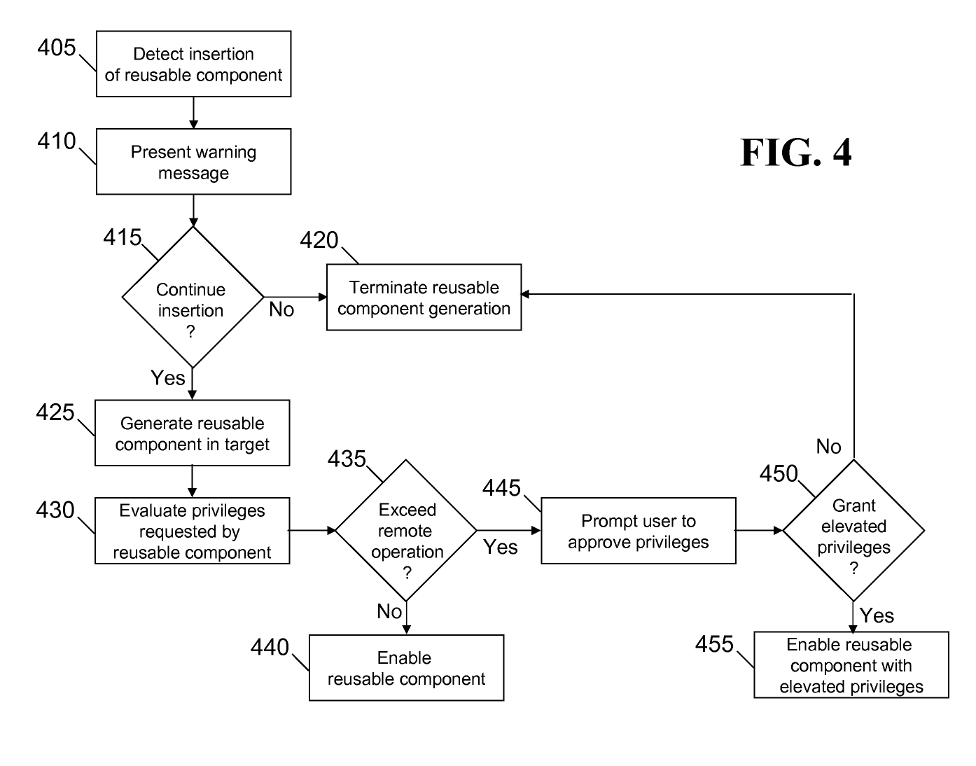

FIG. 4 shows a flowchart describing an exemplary process for securing an instance of a reusable component inserted into a target application. The insertion of a reusable component into a target application is detected (405). For example, a reusable component can be inserted into a target application by dropping a reusable component in a target application window. Further, a reusable component also can be inserted into a target application based on an application fragment, such as by dropping the application fragment into the target application window or by selecting an option associated with the application fragment.

Upon identifying the insertion of a reusable component into a target application, a warning message can be presented (410). For example, the message can inform a user that a reusable component may include malicious content. The message can be displayed in the target application window or any other portion of the GUI. Further, the message can prompt the user to confirm that the reusable component should be inserted into the target application and can include one or more buttons configured to receive input from the user. In some implementations, the warning message can be presented only when the reusable component is received from a remote source or an unvalidated source. Additionally, an application fragment generated in a local computing system based on information received from a remote source or an unvalidated source can include an indicator that the application fragment has not been validated. In other implementations, warning message presentation can be modified, such as in response to a user selection. For example, warning messages can be disabled for a particular application or can be filtered, such as based on the domain from which a reusable component is received. Once the warning message is presented, it is determined whether to continue insertion of the reusable component (415).

If insertion is not to be continued, generation of the reusable component is terminated (420). For example, a user can indicate that the insertion operation is to be canceled in response to the warning message. Otherwise, the reusable component is generated in the target window (425). Further, the privileges requested by the reusable component are evaluated (430). For example, the target application or application environment can determine which resources the reusable component will seek access to once the reusable component is enabled, such as file system access, network access, and storage access. In some implementations, the clipboard used to transfer the reusable component can include information, such as computer code and/or parameters, that indicate the privileges that will be requested by the reusable component. In some implementations, the reusable component will not request any privileges. In such circumstances, the target application can presume that the reusable component is requesting a default set of privileges, such as full system access or no system access.

Once the requested privileges have been identified, it is determined whether the privileges exceed those granted to the reusable component when it is executing in a remote application hosted on the local computing system, such as in a web browser window (435). If the requested privileges do not exceed those granted when the reusable component executes in a remote application, the reusable component can be enabled in the target application (440). Additionally, the privileges granted to the reusable component in the target application can be restricted, such that the reusable component cannot automatically obtain additional privileges after it is enabled.

If the requested privileges exceed those granted when the reusable component executes in a remote application, the target application or application environment can prompt the user to approve the assignment of privileges to the reusable component (445). For example, a text box or message can be displayed to the user, indicating that the reusable component has requested one or more privileges that exceed the privileges granted to the reusable component when it is executing in a remote application. One or more buttons or other input devices also can be presented through which the user can indicate approval/disapproval of granting the elevated privileges. It can then be determined whether to grant the elevated privileges (450).

If elevated privileges are not to be granted to the reusable component, generation of the reusable component is terminated (420). Alternatively, the reusable component can be assigned privileges corresponding to those granted when the reusable component is executing in a remote application. If elevated privileges are to be granted to the reusable component, the reusable component can be enabled with one or more elevated privileges (455). Further, despite being assigned one or more elevated privileges, the reusable component can be constrained. For example, the reusable component can be assigned to a sandbox in which it can be executed. The sandbox can provide only the privileges and access to resources granted to the reusable component. Other privileges and access to resources can be restricted and the reusable component can be isolated from the remainder of the computing system hosting the target application. In some implementations, a plurality of sandboxes having different levels of privileges and access can be defined. A reusable component can be assigned to a particular sandbox based on the privileges and access to resources that have been granted.

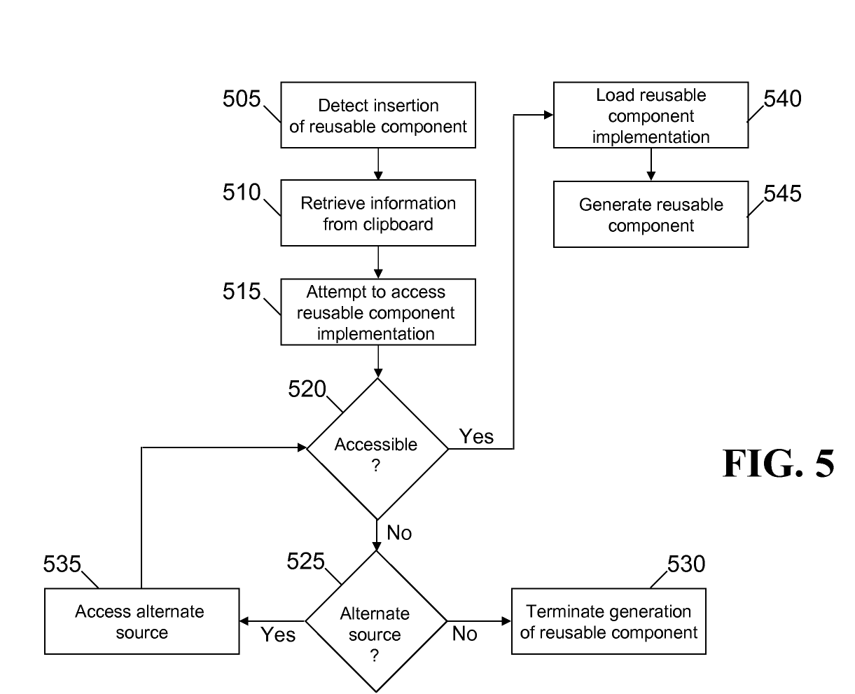

FIG. 5 shows a flowchart describing an exemplary process for generating an instance of a reusable component in a target application window. The insertion of a reusable component into a target application is detected (505). For example, a reusable component can be inserted by dropping the reusable component in the target application window. Further, a reusable component also can be inserted into a target application based on an application fragment, such as by dropping the application fragment into the target application window or by selecting an option associated with the application fragment.

Information associated with the reusable component is retrieved from the clipboard, such as the local system clipboard (510). For example, the clipboard can include a name of the reusable component, a pointer to a library implementing the reusable component, and information describing the state of the reusable component. The pointer can be any location identifier, including a URI or a URL. In some implementations, the pointer can identify an embedded application that can be downloaded. Also, a library can include an implementation of one or more reusable components. Further, an attempt can be made to access the library implementing the reusable component (515). For example, the target application in which the reusable component is being inserted or the application environment in which the target application is executing can attempt to access the location in which the library is maintained. For a reusable component transferred from a remote source, the library can be stored in a remote location.

The target application or application environment determines whether the library or other such reusable component implementation is accessible (520). If the library is not accessible, such as if the pointer included in the clipboard is inoperative, it can be determined whether an alternate source for the reusable component implementation is available (525). If no alternate source is available, generation of the reusable component in the target application can be terminated (530). Alternatively, one or more additional attempts to access the library can be made before generation of the reusable component is terminated. If one or more alternate sources are available (535), the target application or application environment can attempt to access the alternate sources until a corresponding reusable component implementation is accessible or the alternate sources have been exhausted.

If the library is accessible, the reusable component implementation can be loaded (540). For example, the reusable component implementation can be loaded from a remote location into a storage location accessible to the target application, such as a directory associated with the target application. Alternately, the reusable component implementation can be downloaded from the remote location to the computing system in which the target application is executing. The reusable component implementation then can be loaded into a storage location accessible to the target application from the downloaded local copy. Once loaded, the reusable component can be generated in the target application based on the reusable component implementation (545).

In some implementations, information defining the reusable component implementation can be copied into the clipboard from the source application. For example, the reusable component in the source application can be implemented in a library. When the reusable component is selected and dragged from the source application, the instructions, such as byte code, corresponding to the reusable component can be copied into the clipboard. Thus, information corresponding to the library can be accessed in the clipboard and need not be separately retrieved from a remote source.

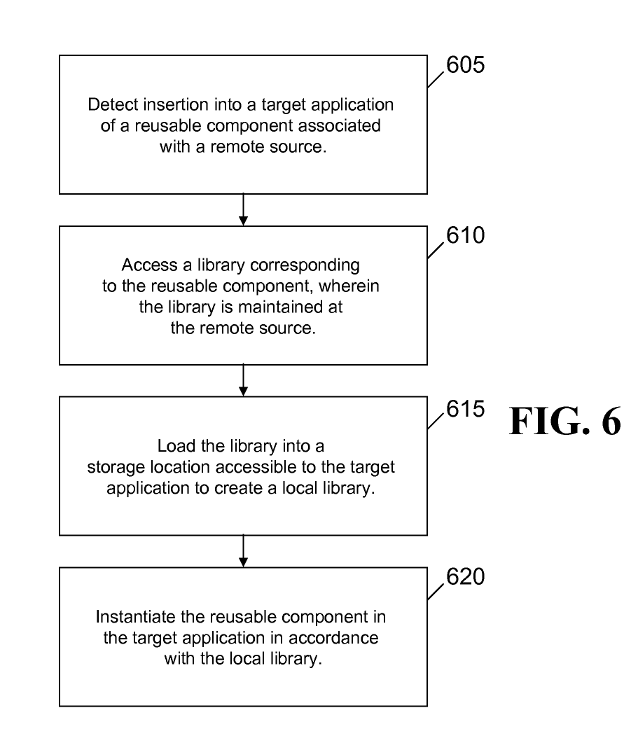

FIG. 6 shows a computer-implemented method of reusing a component. Initially, insertion into a target application of a reusable component associated with a remote source is detected (605). A library corresponding to the reusable component is accessed, wherein the library is maintained at the remote source (610). The library is loaded into a storage location accessible to the target application to create a local library (615). Once the local library has been created, the reusable component is instantiated in the target application in accordance with the local library (620).

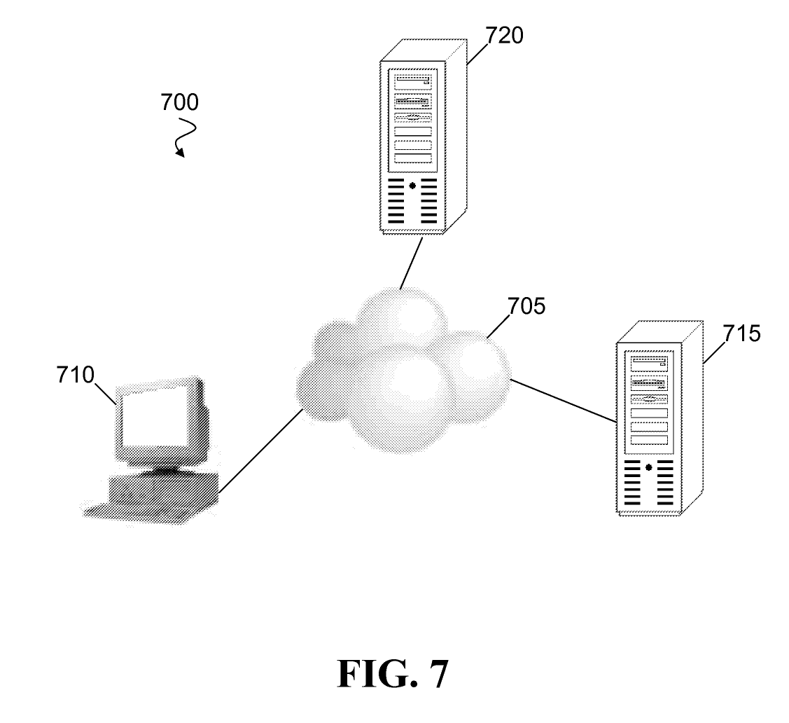

FIG. 7 shows an exemplary computing environment 700. A communication network 705 can connect one or more devices hosted in the computing environment 700. The communication network 705 can be any type of network, including a local area network (“LAN”), such as an intranet, and a wide area network (“WAN”), such as the Internet. Further, the communication network 705 can be a public network, a private network, or any combination thereof. The communication network 705 also can include wired communication paths and/or wireless communication paths associated with one or more service providers. Additionally, the communication network 705 can be configured to support the transmission of messages formatted using a variety of protocols.

One or more computers, such as the computer 710, can be included in the computing environment 700. The computer 710 can be coupled to the communication network 705 to permit communication with one or more remote computing systems. The computer 710 further can include a processor, memory, and non-volatile storage configured to store and execute one or more application programs. Also, the computer 710 can include one or more interfaces, such as a display, a speaker, a keyboard, a mouse, a joystick, a trackball, a touch pad, a touch screen, and a microphone/voice recognition. Further, the computing environment 700 can include one or more servers, such as the servers 715 and 720. The servers also can include a processor, memory, and non-volatile storage configured to store and execute one or more application programs. Additionally, a server can be configured to respond to a request from a client computer, such as the computer 710, to execute or download an application hosted by the server.

Further, the computer 710 can be configured to present an interface (not shown), such as a desktop, in which one or more local application windows, remote application windows, and/or file system views can be presented. Additionally, a remote application window presented on the computer 710 can include content associated with a remote application, such as an application stored and/or executed at a server coupled to the communication network 705. In presenting a remote application window, the computer 710 can communicate bi-directionally with one or more servers associated with the corresponding remote application, such as the servers 715 and 720.

Embodiments of the subject matter and the functional operations described in this specification can be implemented in digital electronic circuitry, or in computer software, firmware, or hardware, including the structures disclosed in this specification and their structural equivalents, or in combinations of one or more of them. Embodiments of the subject matter described in this specification can be implemented as one or more computer program products, i.e., one or more modules of computer program instructions encoded on a computer-readable medium for execution by, or to control the operation of, data processing apparatus. The computer-readable medium can be a machine-readable storage device, a machine-readable storage substrate, a memory device, a composition of matter effecting a machine-readable propagated signal, or a combination of one or more of them. The term “data processing apparatus” encompasses all apparatus, devices, and machines for processing data, including by way of example a programmable processor, a computer, or multiple processors or computers. The apparatus can include, in addition to hardware, code that creates an execution environment for the computer program in question, e.g., code that constitutes processor firmware, a protocol stack, a database management system, an operating system, or a combination of one or more of them. A propagated signal is an artificially generated signal, e.g., a machine-generated electrical, optical, or electromagnetic signal, that is generated to encode information for transmission to suitable receiver apparatus.

A computer program (also known as a program, software, software application, script, or code) can be written in any form of programming language, including compiled or interpreted languages, and it can be deployed in any form, including as a stand-alone program or as a module, component, subroutine, or other unit suitable for use in a computing environment. A computer program does not necessarily correspond to a file in a file system. A program can be stored in a portion of a file that holds other programs or data (e.g., one or more scripts stored in a markup language document), in a single file dedicated to the program in question, or in multiple coordinated files (e.g., files that store one or more modules, sub-programs, or portions of code). A computer program can be deployed to be executed on one computer or on multiple computers that are located at one site or distributed across multiple sites and interconnected by a communication network.

The processes and logic flows described in this specification can be performed by one or more programmable processors executing one or more computer programs to perform functions by operating on input data and generating output. The processes and logic flows can also be performed by, and apparatus can also be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto-optical disks, or optical disks. However, a computer need not have such devices. Moreover, a computer can be embedded in another device, e.g., a mobile telephone, a personal digital assistant (PDA), a mobile audio player, a Global Positioning System (GPS) receiver, to name just a few. Computer-readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto-optical disks; and CD-ROM and DVD-ROM disks. The processor and the memory can be supplemented by, or incorporated in, special purpose logic circuitry.

To provide for interaction with a user, embodiments of the subject matter described in this specification can be implemented on a computer having a display device, e.g., a CRT (cathode ray tube) or LCD (liquid crystal display) monitor, for displaying information to the user and a keyboard and a pointing device, e.g., a mouse or a trackball, by which the user can provide input to the computer. Other kinds of devices can be used to provide for interaction with a user as well; for example, feedback provided to the user can be any form of sensory feedback, e.g., visual feedback, auditory feedback, or tactile feedback; and input from the user can be received in any form, including acoustic, speech, or tactile input.

Embodiments of the subject matter described in this specification can be implemented in a computing system that includes a back-end component, e.g., as a data server, or that includes a middleware component, e.g., an application server, or that includes a front-end component, e.g., a client computer having a graphical user interface or a Web browser through which a user can interact with an implementation of the subject matter described is this specification, or any combination of one or more such back-end, middleware, or front-end components. The components of the system can be interconnected by any form or medium of digital data communication, e.g., a communication network. Examples of communication networks include a local area network (“LAN”) and a wide area network (“WAN”), e.g., the Internet.

The computing system can include clients and servers. A client and server are generally remote from each other and typically interact through a communication network. The relationship of client and server arises by virtue of computer programs running on the respective computers and having a client-server relationship to each other.

While this specification contains many specifics, these should not be construed as limitations on the scope of the invention or of what may be claimed, but rather as descriptions of features specific to particular embodiments of the invention. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the embodiments described above should not be understood as requiring such separation in all embodiments, and it should be understood that the described program components and systems can generally be integrated together in a single software product or packaged into multiple software products.

Thus, particular embodiments of the invention have been described. Other embodiments are within the scope of the following claims. For example, the actions recited in the claims can be performed in a different order and still achieve desirable results.

What is claimed is:

1. A computer-implemented method of reusing a component, the method comprising:
causing display on a local computing system, of a first graphical user interface for a web-based application hosted by a server system communicatively coupled with the local computing system, and wherein the web-based application includes an executing reusable component presented in the user interface;
detecting insertion of the reusable component into a second graphical user interface for a target application executing on the local computing system, wherein the reusable component is executing in the web-based application contemporaneously with detecting insertion of the reusable component into the second a graphical user interface for the target application; and
instantiating the reusable component in the target application in accordance with a local library corresponding to the reusable component.

2. The computer-implemented method of claim 1, further comprising granting limited system privileges to the reusable component.

3. The computer-implemented method of claim 2, further comprising assigning the reusable component to a sandbox based on one or more granted system privileges.

4. The computer-implemented method of claim 1, wherein the local library is based on a remote library maintained on a remote server system, wherein the remote library includes implementations of a plurality of reusable components.

5. The computer-implemented method of claim 1, wherein detecting insertion further comprises:
detecting an operation dropping the reusable component into the second graphical user interface for the target application.

6. The computer-implemented method of claim 1, further comprising:
retrieving, by the target application, information associated with the reusable component from a clipboard, the information including a name describing the reusable component, a pointer to a library implementing the reusable component, and state information describing a state of the reusable component.

7. The computer-implemented method of claim 1, wherein the reusable component is defined in an application fragment.

8. The computer-implemented method of claim 1, wherein the reusable component comprises a dynamic component configured to retrieve one or more executable instructions from a remote location.

9. A computer program product, encoded on a computer-readable medium, operable to cause a data processing apparatus to perform operations comprising:
causing display on a local computing system, of a first graphical user interface for a web-based application hosted by a server system communicatively coupled with the data processing apparatus, and wherein the web-based application includes an executing reusable component presented in the user interface;
detecting insertion of the reusable component into a second graphical user interface for a target application executing on the local computing system, wherein the reusable component is executing in the web-based application contemporaneously with detecting insertion of the reusable component into the second graphical user interface; and
instantiating the reusable component in the target application in accordance with a local library corresponding to the reusable component.

10. The computer program product of claim 9, further operable to cause data processing apparatus to perform operations comprising granting limited system privileges to the reusable component.

11. The computer program product of claim 10, further operable to cause data processing apparatus to perform operations comprising assigning the reusable component to a sandbox based on one or more granted system privileges.

12. The computer program product of claim 9, wherein the local library is based on a remote library maintained on a remote server system, wherein the remote library includes implementations of a plurality of reusable components.

13. The computer program product of claim 9, wherein detecting insertion further comprises detecting an operation dropping the reusable component-into the second graphical user interface for the target application.

14. The computer program product of claim. 9, further operable to cause data processing apparatus to perform operations comprising retrieving information associated with the reusable component from a clipboard, the information including a name describing the reusable component, a pointer to a library implementing the reusable component, and state information describing a state of the reusable component.

15. The computer program product of claim 9, wherein the reusable component is defined in an application fragment.

16. The computer program product of claim 9, wherein the reusable component comprises a dynamic component configured to retrieve one or more executable instructions from a remote location.

17. A system comprising:
a target application stored on a computer-readable medium;
a computing system communicatively coupled, via the communications network, with a server system, the computing system including processor electronics configured to perform operations comprising:
causing display, on the computing system, of a first graphical user interface for the web-based application, wherein the web-based application includes an executing reusable component presented in the user interface;
detecting insertion of the reusable component into a second graphical user interface for a target application executing on the computing system, wherein the reusable component is executing in the web-based application contemporaneously with detecting insertion of the reusable component into the second graphical user interface; and
instantiating the reusable component in the target application in accordance with a local library corresponding to the reusable component.

18. The system of claim 17, wherein the processor electronics are further configured to perform operations comprising granting limited system privileges to the reusable component.

19. The system of claim 18, wherein the processor electronics are further configured to perform operations comprising assigning the reusable component to a sandbox based on one or more granted system privileges.

20. The system of claim 17, wherein the local library is based on a remote library maintained on the server system, wherein the remote library includes implementations of a plurality of reusable components.

21. The system of claim 17, wherein detecting insertion further comprises detecting an operation dropping the reusable component into the second graphical user interface for the target application,

22. The system of claim 17, wherein the processor electronics are further configured to perform operations comprising retrieving information associated with the reusable component from a clipboard, the information including a name describing the reusable component, a pointer to a library implementing the reusable component, and state information describing a state of the reusable component.

23. The system of claim 17, wherein the reusable component is defined in an application fragment,

24. The system of claim 17, wherein the reusable component comprises a dynamic component configured to retrieve one or more executable instructions from a remote location.
